(19) United States
(12) Patent Application Publication
(10) Pub. No.: US 2023/0327528 A1
(43) Pub. Date: Oct. 12, 2023

(54) STATOR FOR AN ELECTRIC ROTATING MACHINE

(71) Applicant: Siemens Aktiengesellschaft, München (DE)

(72) Inventors: Rolf Vollmer, Gersfeld (DE); Frank Mutzbauer, Hollstadt (DE)

(73) Assignee: Siemens Aktiengesellschaft, München (DE)

(21) Appl. No.: 18/131,157

(22) Filed: Apr. 5, 2023

(30) Foreign Application Priority Data
Apr. 6, 2022 (EP) 22166933.6

(51) Int. Cl. H02K 15/02; H02K 1/02; H02K 1/16; H02K 15/085; B22F 5/08; B22F 3/10

(52) U.S. Cl. CPC H02K 15/024; H02K 1/02; H02K 1/16; H02K 15/085; B22F 5/08; B22F 2302/45; B22F 2999/00; B22F 2998/10; B22F 2301/15; B22F 2301/35; B22F 2302/05; B22F 3/1003

(57) ABSTRACT

In a method for producing a stator for an electric rotating machine, first material layers of a first metal material are produced from a green body by a sintering process. The first material layers of the first metal material are stacked to form a toothed arrangement comprised of a plurality of radially oriented teeth and an inner ring to connect the teeth. Each of the first material layers has a first thickness in a range of 10 μm to 250 μm, in particular in a range of 10 μm to 100 μm. Second material layers of a second metal material are stacked to form a yoke, with the first metal material having a saturation induction which is higher than a saturation induction of the second metal material. The yoke is joined to the toothed arrangement to form a material layer structure, and the inner ring is removed.

### CROSS-REFERENCES TO RELATED APPLICATIONS

This application claims the priority of German Patent Application, Serial No. 22166933.6, filed Apr. 6, 2022, pursuant to 35 U.S.C. 119(a)-(d), the disclosure of which is incorporated herein by reference in its entirety as if fully set forth herein.

### BACKGROUND OF THE INVENTION

The present invention relates to a method for producing a stator for an electric rotating machine, to a stator for an electric rotating machine, and to an electric rotating machine.

The following discussion of related art is provided to assist the reader in understanding the advantages of the invention, and is not to be construed as an admission that this related art is prior art to this invention.

In electric rotating machines, which can be operated, for example, as a motor and/or as a generator, laminated cores composed of stacked electric metal sheets are customarily used to suppress the spread of eddy currents. The electric metal sheets, which contain, for example, a soft magnetic material, in particular iron, are customarily cut or punched from rolled large metal sheets. The metal sheets are then stacked to form a laminated core. A conventional production method of this kind has shortcomings because of the inability to produce metal sheets with a layer thickness of less than 100 μm on a large scale. In addition, waste accrues when cutting or punching the metal sheets from large metal sheets.

It would therefore be desirable and advantageous to address these problems and to obviate other prior art shortcomings in an inexpensive manner and with improved eco-balance.

### SUMMARY OF THE INVENTION

According to one aspect of the invention, a method for producing a stator for an electric rotating machine includes producing first material layers of a first metal material from a green body by a sintering process, in particular pressureless sintering process, with each of the first material layers having a first thickness in a range of 10 μm to 250 μm, in particular in a range of 10 μm to 100 μm, stacking the first material layers of the first metal material such as to form a toothed arrangement comprised of a plurality of radially oriented teeth and an inner ring to connect the teeth, stacking second material layers of a second metal material such as to form a yoke, with the first metal material having a saturation induction which is higher than a saturation induction of the second metal material, joining the yoke to the toothed arrangement to form a material layer structure, and removing the inner ring.

According to another aspect of the invention, a stator for an electric rotating machine includes a toothed arrangement including a plurality of radially oriented teeth and produced from stacked first material layers of a first metal material having each a first thickness in a range of 10 μm to 250 μm, and a yoke joined to the toothed arrangement to form a material layer structure and produced from stacked second material layers of a second metal material, with the first metal material having a saturation induction which is higher than a saturation induction of the second metal material, wherein the first material layers are each produced from a green body by a sintering process.

According to still another aspect of the invention, an electric rotating machine includes a stator as set forth above.

The invention is based on a recognition to enable production of a stator for an electric rotating machine having a yoke and a toothed arrangement with the use of different materials and production methods for the material layers of the yoke and the toothed arrangement. During production of the stator, first material layers made of a first metal material for the toothed arrangement, which comprises a plurality of radially oriented teeth and an inner ring, and second material layers made of a second metal material are stacked to form the yoke. Stacking of the material layers can include, inter alia, pressing and gluing the material layers in order to obtain the yoke or the toothed arrangement. The first metal material has a higher saturation induction, also called saturation flux density, than the second metal material. Advantageously, the saturation induction of the first metal material can be less than 2.2 T, while the saturation induction of the second metal material can be at least 2.25 T. For example, a nickel-iron alloy with a saturation induction in the range of 1.2 T to 1.5 T can be used for the yoke, while an iron-cobalt alloy with a saturation induction in the range of 2.25 to 2.35 T can be used for the toothed arrangement. A nickel-iron alloy is characterized by a low loss coefficient, while the iron-cobalt alloy has a high saturation flux density. The teeth of the toothed arrangement are magnetically loaded to a greater extent during operation of the stator than the yoke, which conveys the magnetic flux from tooth to tooth, so a more inexpensive alloy with lower saturation flux density can be used in the yoke. A higher saturation induction enables a material layer design with narrower teeth and thus larger grooves for receiving magnetic coils, increasing a torque and a power of the electric rotating machines. Similarly, higher degrees of efficiency are achieved, and this, in addition to the cost savings, also results in a lower CO₂ emission and therewith in an improved eco-balance during operation.

In further steps, the yoke having the toothed arrangement is joined to a material layer structure and the inner ring is removed. Yoke and teeth can be joined, for example by positive fit, inter alia by jamming, but also by way of an integral connection, inter alia by welding or gluing.

At least the first material layers of the toothed arrangement are each produced from a green body by a sintering process. The green body can be produced through an additive method, involving, i.a., screen printing, stencil printing and web-fed printing. The first material layers produced by the sintering process each have a first thickness in the range of 10 μm to 250 μm, in particular in the range of 10 μm to 100 μm. Eddy current losses are significantly reduced by such low layer thicknesses, whereby a higher degree of efficiency is achieved. The use of such printed and sintered material layers prevents waste, and this also improves the eco-balance and results in a cost saving.

According to another advantageous feature of the invention, each of the second material layers can have a second thickness which is greater than the first thickness of the first material layers. For example, the first material layers have a thickness of 20 μm, while the second material layers have a thickness of 100 μm. Eddy current losses in the teeth that are magnetically loaded to a great extent are significantly reduced by such a stator design and at the same time costs are cut due to the lower number of layers in the yoke.

According to another advantageous feature of the invention, the second material layers can be designed as electric metal sheets, which are produced by a punching process or a laser cutting process. In particular, the yoke that is magnetically loaded to a lesser extent is produced by a punch-stacking process, resulting in a cost saving.

According to another advantageous feature of the invention, the second material layers can be produced from a green body by a sintering process, in particular pressureless, sintering process. The green body for the second material layers may also be produced through an additive method such as screen printing, stencil printing and web-fed printing. The sintering process makes lower layer thicknesses possible, thereby significantly reducing eddy current losses and achieving a higher degree of efficiency. Furthermore, waste is prevented so as to have a positive effect on the eco-balance.

According to another advantageous feature of the invention, the green body for production of the first material layers and/or the second material layers can be produced from a suspension, which comprises solid alloy particles, sintering aids, in particular sintering aids in powder form, and a binder, with the sintering aids forming eutectics. With the alloys to be sintered, the sintering aids form eutectics to largely prevent cavities and pores, so that a high density is achieved, in particular when a pressureless sintering process is involved.

According to another advantageous feature of the invention, provision can be made for the use of solid alloy particles for the green body of the first material layers, with the solid alloy particles containing iron and cobalt. The second material layers can be produced from pure iron or an iron alloy with a saturation induction of less than 2.2 T. The use of first material layers made of an iron-cobalt alloy, which contains, for example, cobalt with a percentage by weight in the range of 47% to 50%, makes it possible to reduce the size of the teeth for conveying the magnetic flux to enable larger grooves for receiving magnetic coils, increasing a torque and a power of the electric rotating machines. The use of less expensive iron alloys in the yoke that is magnetically loaded to a lesser extent cuts costs.

According to another advantageous feature of the invention, the sintering aids can be added to the suspension and can contain a phosphorus compound and/or a boron compound. Examples of such sintering aids include iron phosphides and/or iron borides that are particularly well suited to forming eutectics when a pressureless sintering process is involved, so that cavities and pores are largely prevented and high density is achieved.

According to another advantageous feature of the invention, sintering aids can added to the suspension such that the sintered first material layers and/or second material layers have a percentage by weight in the range of 0.4% to 1%. Particularly good results in respect of the prevention of cavities and pores could be achieved by such a proportion of sintering aids in the involved sintering process.

According to another advantageous feature of the invention, coils, in particular toothed coils, can be inserted in the toothed arrangement before the yoke is joined to the toothed arrangement, with the coils being potted with the toothed arrangement. In this way, joining can also be implemented inexpensively and easily when using relatively narrow teeth.

According to another advantageous feature of the invention, the yoke can be joined to the toothed arrangement by grouting. Joining by way of grouting can be implemented inexpensively, reliably and easily.

According to another advantageous feature of the invention, the inner ring can be removed by cutting or by a laser-based method. A cutting method, for example milling, can be implemented inexpensively, reliably and easily. A laser-based method prevents, in particular in the case of sintered metal sheets, chips, which can cause short-circuit in the stator, so that a laser-based method increases reliability.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic longitudinal section of a toothed arrangement,

FIG. 2 is a schematic representation of a first method for producing a stator,

FIG. 3 is a schematic representation of a second method for producing a stator,

FIG. 4 is a schematic cross-section of a stator, and

FIG. 5 is a schematic longitudinal section of an electric rotating machine.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

The exemplary embodiment explained below is a preferred embodiment of the invention. In the exemplary embodiment, the described components of the embodiment each represent individual features of the invention that are to be considered independently of each other, which also each develop the invention independently of one another and should therewith also be regarded, individually or in a combination different to that shown, as a constituent part of the invention. Furthermore, the described embodiment can also be supplemented by further features of the invention that have already been described.

Turning now to the drawing, and in particular to FIG. 1, there is shown a schematic longitudinal section of a toothed arrangement 2, which is produced from stacked first material layers 4 and comprises a centrally arranged recess 6 through which an axis of rotation 8 runs. The toothed arrangement 2 can be configured for a stator or a rotor of an electric rotating machine. If the toothed arrangement 2 is configured for application in a stator, the recess 6 is provided for receiving a rotor. If the toothed arrangement 2 is configured for application in a rotor, the recess 6 is provided for subsequent attachment to a shaft.

The first material layers 4 each have a first thickness d1 in the range of 10 μm to 250 μm, in particular in the range of 10 μm to 100 μm, and are each produced from a green body by means of a pressureless sintering process. A green body of this kind for obtaining a first material layer 4 is produced by means of an additive method from a suspension, which comprises solid alloy particles, sintering aids, in particular in powder form, and at least one binder. Additive methods of this kind can be, inter alia, screen printing, stencil printing and web-fed printing. The binder, which acts as a liquid adhesive, can be, for example, an organic binder, which is removed prior to sintering or during the sintering process. In particular, the suspension is in the form of a paste.

Solid alloy particles, which contain iron and cobalt, are used for obtaining an iron-cobalt alloy for the green body of the first material layers 4. Advantageously, the alloy contains cobalt having a percentage by weight in the range of 47% to 50%. Sintering aids in powder form are added to the suspension, and these contain phosphorus compounds, for example iron phosphides, and/or boron compounds, for example iron borides. In the sintered first material layers 4 the sintering aids have a percentage by weight in the range of 0.4% to 1%. With the alloys to be sintered, the sintering aids form eutectics, whereby cavities and pores are largely prevented, so a high density is achieved with a pressureless sintering process

The stacked first material layers 4 have, for example on one layer side, an insulating layer 10, which contains, for example, an enamel, in particular a baked enamel. In addition or alternatively, the insulating layer 10 can contain a metal oxide, for example an iron oxide or aluminum oxide.

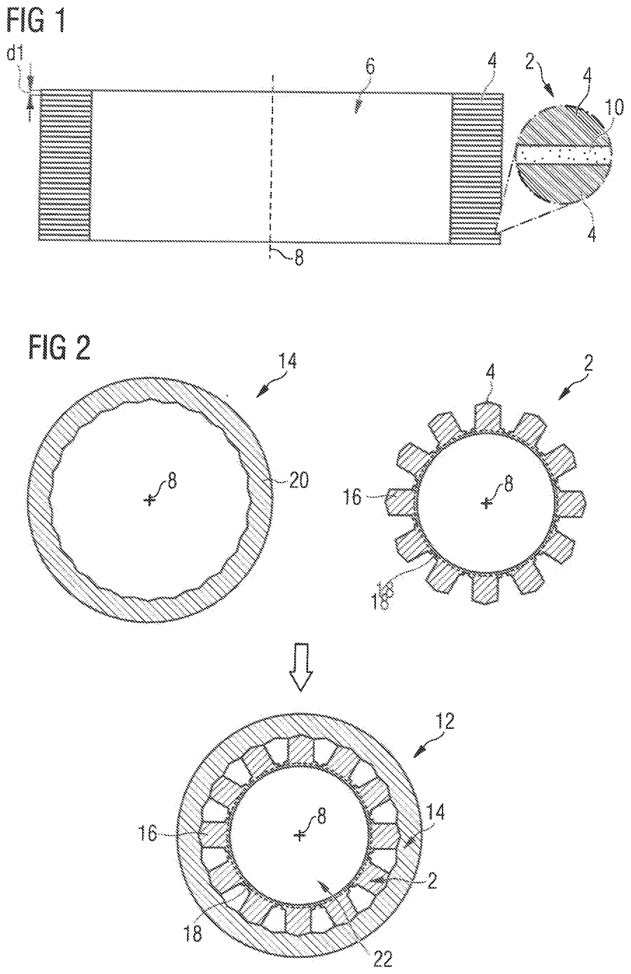

FIG. 2 shows a schematic representation of a first method for producing a stator 12, which can be used in an electric rotating machine. The stator 12 comprises a, by way of example, annular, yoke 14 and the toothed arrangement 2 described in FIG. 1. The toothed arrangement 2, which is constructed from stacked first material layers 4, which are produced from an iron-cobalt alloy, has a plurality of radially oriented teeth 16 and an inner ring 18, which connects the teeth 16. The yoke 14 is constructed by stacking second material layers 20, which are produced from a first metal material. The second material layers 20 are produced from pure iron and have iron with a percentage by weight of at least 97%. The first material layers 4 are thus produced from a material, which has a higher saturation induction than the material from which the second material layers 20 are produced. Furthermore, the first material layers 4 have a lower layer thickness than the second material layers 20.

The second material layers 20 produced from pure iron can be designed, inter alia, as electric metal sheets, which are joined, in particular, by punch-stacking. Alternatively, the second material layers 20, analogously to the first material layers 4, can be produced by, in particular pressureless, sintering. A green body to be sintered in order to obtain a second material layer 20 is likewise produced by means of the additive method from a suspension, which comprises solid alloy particles, in particular sintering aids in powder form, and at least one binder. The solid alloy particles for producing a second material layer 20 are iron particles. Sintering aids in powder form are added to the suspension for producing a second material layer 20, which aids contain phosphorus compounds, for example iron phosphides, and/or boron compounds, for example iron borides. In the sintered second material layer 20 the sintering aids have a percentage by weight in the range of 0.4% to 1%.

Joining of the yoke 14 to the toothed arrangement 2 to form a material layer structure 22 follows in a further step. The yoke 14 is joined to the toothed arrangement 2, for example by grouting. The inner ring 18 is then removed by means of a cutting or by means of a laser-based method. A stator winding with coils, in particular toothed coils, can be inserted before or after removal of the inner ring 18. After insertion, of the coils the arrangement can be fixed by potting. With a winding potted in the toothed arrangement 2, the inner ring 18 can be removed by eroding since the winding can no longer absorb water. The further embodiment of the toothed arrangement 2 in FIG. 2 corresponds to that in FIG. 1.

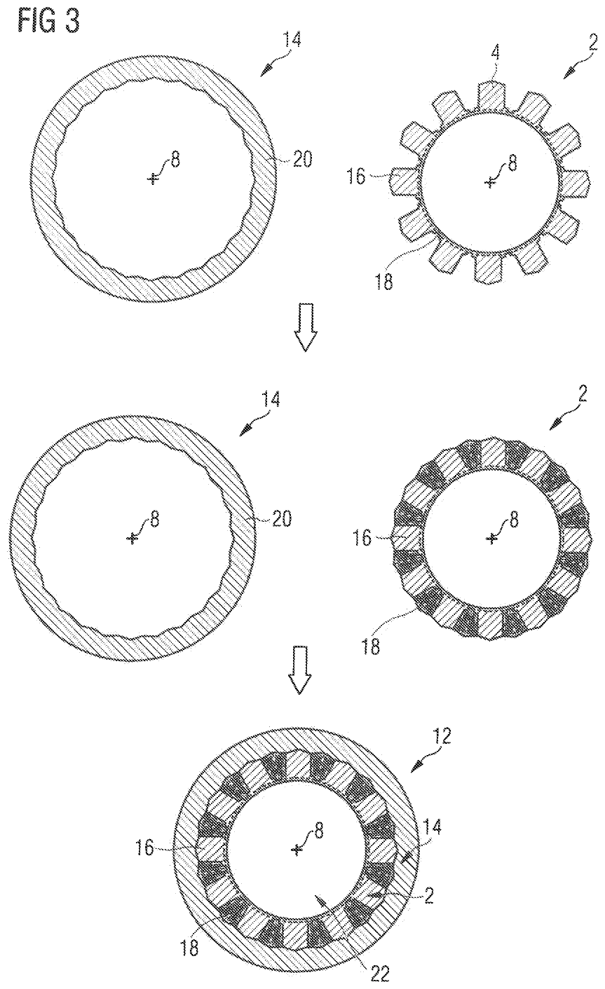

FIG. 3 shows a schematic representation of a second method for producing a stator 12, wherein before the yoke 14 is joined to the toothed arrangement 2, coils 24 are inserted in the toothed arrangement 2. The coils 24 are designed as toothed coils and after insertion are fixed to the toothed arrangement 2 by potting. The further embodiment of the stator 12 in FIG. 3 corresponds to that in FIG. 2.

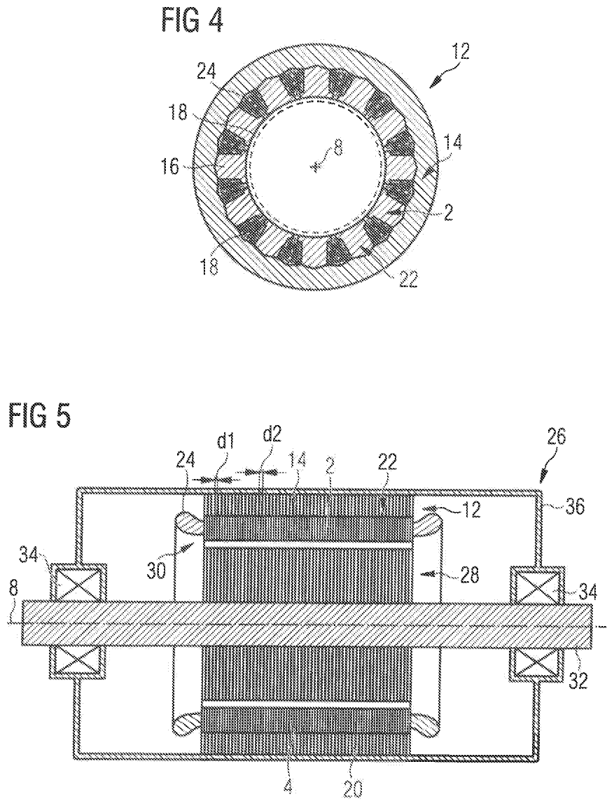

FIG. 4 shows a schematic cross-section of a stator 12. The teeth 16 are produced from an iron-cobalt alloy while the yoke is produced from pure iron. Furthermore, the stator 12 is produced according to the method described in FIG. 3.

FIG. 5 shows a schematic longitudinal section of an electric rotating machine 26, which is designed, for example, as a synchronous machine. The synchronous machine has a rotor 28 which can rotate about an axis of rotation 8 and a stator 12 surrounding the rotor 28. Between the rotor 28 and the stator 12 is a gap 30, which is designed, in particular, as an air gap. The rotor 28 comprises a shaft 32, which is mounted via bearings 34. The rotor 28 and the stator 12 are accommodated, for example, in a housing 36. The stator 12 comprises a material layer structure 22 having a toothed arrangement 2 and a yoke 14. The toothed arrangement 2 has first material layers 4 and the yoke 14 has second material layers 20, with the first material layers 4 of the toothed arrangement 2 having a first thickness d1 and the second material layers 20 of the yoke 14 having a second thickness d2, which is greater than the first thickness d1. The further embodiment of the stator 12 in FIG. 5 corresponds to that in FIG. 4.

In summary, the invention relates to a stator 12 for an electric rotating machine 26. In order to save costs and achieve an improved eco-balance the following steps are proposed: stacking first material layers 4, which are produced from a first metal material, to form a toothed arrangement 2, which comprises a plurality of radially oriented teeth 16 and an inner ring 18, which connects the teeth 16, stacking second material layers 20, which are produced from a second metal material, to form a yoke 14, wherein the first metal material has a higher saturation induction than the second metal material, joining the yoke 14 to the toothed arrangement 2 to form a material layer structure 22, removing the inner ring 18 wherein the first material layers 4 each have a first thickness d1 in the range of 10 μm to 250 μm, in particular in the range of 10 μm to 100 μm, and are each produced from a green body by means of a, in particular pressureless, sintering process.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a stator for an electric rotating machine, said method comprising:
producing first material layers of a first metal material from a green body by a sintering process, in particular pressureless sintering process, each of the first material layers having a first thickness in a range of 10 μm to 250 μm, in particular in a range of 10 μm to 100 μm;
stacking the first material layers of the first metal material such as to form a toothed arrangement comprised of a plurality of radially oriented teeth and an inner ring to connect the teeth;
stacking second material layers of a second metal material such as to form a yoke, with the first metal material having a saturation induction which is higher than a saturation induction of the second metal material;
joining the yoke to the toothed arrangement to form a material layer structure; and
removing the inner ring.

2. The method of claim 1, wherein the second material layers have each a second thickness which is greater than the first thickness.

3. The method of claim 1, wherein the second material layers are designed as electric metal sheets, which are produced by a punching process or a laser cutting process.

4. The method of claim 1, further comprising producing the second material layers from a green body by a sintering process, in particular pressureless, sintering process.

5. The method of claim 1, further comprising producing the green body from a suspension comprising solid alloy particles, sintering aids and a binder, with the sintering aids forming eutectics.

6. The method of claim 5, wherein the sintering aids are in powder form.

7. The method of claim 5, wherein the solid alloy particles contain iron and cobalt.

8. The method of claim 1, wherein the second material layers are produced from pure iron or an iron alloy with a saturation induction of less than 2.2 T.

9. The method of claim 5, wherein the sintering aids are added to the suspension and contain a phosphorus compound and/or a boron compound.

10. The method of claim 5, wherein the sintering aids are added to the suspension such that the sintered first material layers have a percentage by weight in the range of 0.4% to 1%.

11. The method of claim 1, further comprising:
inserting coils, in particular toothed coils, in the toothed arrangement before the yoke is joined to the toothed arrangement; and
potting the coils with the toothed arrangement.

12. The method of claim 1, wherein the yoke is joined to the toothed arrangement by grouting.

13. The method of claim 1, wherein the inner ring is removed by a cutting method or a laser-based method.

14. A stator for an electric rotating machine, said stator comprising:
a toothed arrangement including a plurality of radially oriented teeth and produced from stacked first material layers of a first metal material having each a first thickness in a range of 10 μm to 250 μm; and
a yoke joined to the toothed arrangement to form a material layer structure and produced from stacked second material layers of a second metal material, with the first metal material having saturation induction which is higher than a saturation induction of the second metal material,
wherein the first material layers are each produced from a green body by a sintering process.

15. The stator of claim 14, wherein each of the first material layers has a thickness in a range of 10 μm to 100 μm.

16. The stator of claim 14, wherein each of the second material layers has a second thickness which is greater than the first thickness.

17. The stator of claim 14, wherein the second material layers are designed as electric metal sheets produced by a punching process or a laser cutting process.

18. The stator of claim 14, wherein the second material layers are produced from a green body by a sintering process.

19. The stator of claim 14, wherein the first material layers are produced from an iron-cobalt alloy and the second material layers are produced from pure iron or an iron alloy with a saturation induction of less than 2.2 T.

20. An electric rotating machine, comprising a stator, said stator comprising a toothed arrangement including a plurality of radially oriented teeth and produced from stacked first material layers of a first metal material having each a first thickness in a range of 10 μm to 250 μm, in particular in a range of 10 μm to 100 μm, and a yoke joined to the toothed arrangement to form a material layer structure and produced from stacked second material layers of a second metal material, with the first metal material having a saturation induction which is higher than a saturation induction of the second metal material, wherein the first material layers are each produced from a green body by a sintering process.
